(19) United States
(12) Patent Application Publication
(10) Pub. No.: US 2003/0120862 A1
(43) Pub. Date: Jun. 26, 2003

(54) Controlling method of storage apparatus, and storage apparatus, disk array device, and disk controller used in the method thereof

(75) Inventors: Masato Hirano, Hiratsuka (JP); Akiyoshi Nakano, Odawara (JP); Ikuya Yagisawa, Tokyo (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/105,711

(22) Filed: Mar. 21, 2002

(30) Foreign Application Priority Data
Dec. 20, 2001 (JP) 2001-388162

(51) Int. Cl. G06F 12/00

(52) U.S. Cl. 711/113; 711/154

(57) ABSTRACT

There is provided a controlling method of a storage apparatus connected to an external device constructed by including a cache memory, a data controller controlling the cache memory, a plurality of storage devices, and a device controller controlling the storage devices, where the storage apparatus receives, from the external device, data and a request of writing the data in the storage devices; the data controller directly writes the data in a plurality of regions in the cache memory; and then the device controller writes the data in the storage devices corresponding to the respective regions.

### BACKGROUND OF THE INVENTION

The present application claims priority upon Japanese Patent Application No.2001-388162 filed on Dec. 20, 2001, which is herein incorporated by reference.

### FIELD OF THE INVENTION

The present invention relates to a controlling method of a storage apparatus, and a storage apparatus, a disk array device, and a disk controller that are used in the method thereof.

2. Description of the Related Art

As a technique for ensuring data security in a storage apparatus such as a disk array device that is, for example, typified by RAID1 (redundant array of inexpensive disks), there is known a technique for multiplying and managing data in a plurality of storage devices (for example, disk drives). Further, there may be a case of multiplying and managing data apparatus, in aim to back up data in the background, while maintaining an operating state of a storage.

In a case of multiplying and managing of data in a conventional storage apparatus, a typical method for writing data in a plurality of storage devices is such that data is multiplied and temporarily written in a cache memory and then the respective data are written in the corresponding storage devices by a device controller such as a drive controller.

A schematic block diagram of FIG. 9 and a flowchart of FIG. 10 concretely explain the mechanism described above. Namely, first, a data controller 106 obtains data to be written in disk drives and an address A (S1002) from the external device, and writes data in a region 116 of a cache memory 104, which is specified by the address A (S1004 to S1008). Next, the data controller 106, reads data which is once stored in a region specified by the address A (S1010 to S1014), and writes the data in a region 120 of a cache memory 104, which is specified by an address B (S1016 to S1020).

As shown in FIG. 9, during these processes, containing a data-writing process 124, a data-reading process 118, and another data-writing process 122 of the data once read, a total of three times of I/O occurs in between the data controller 106 and the cache memory 104. Especially, among these processes, the I/O occurring during the data-reading process 118 which is necessary for copying data from the address A to the address B, decreases bus efficiency between the data controller 106 and the cache memory 104, and may cause an increase in a processing time of the storage apparatus itself.

### SUMMARY OF THE INVENTION

The present invention is made in view of the above and other matters, and it is an object to provide, a controlling method of a storage apparatus when multiplying and managing data, and a storage apparatus, a disk array device, and a disk controller used in the method thereof, where a data-writing in the storage devices may be efficiently processed.

One aspect of a controlling method of a disk device of the present invention for achieving the above and other objects, is a controlling method of a storage apparatus, which is connected to an external device, comprising a cache memory, a data controller controlling the cache memory, a plurality of storage devices, and a device controller controlling the storage devices, and the storage apparatus receives, from the external device, data and a request of writing data in the storage devices; the data controller directly writes the data in a plurality of regions in the cache memory; and the device controller writes the data in the storage devices corresponding to the respective regions.

### BRIEF DESCRIPTION OF THE DRAWINGS

For a more complete understanding of the present invention and the advantages thereof, reference is now made to the following description taken in conjunction with the accompanying drawings wherein:

FIG. 1 is a diagram showing an entire constitution of hardware according to an embodiment of the present invention;

FIG. 2 is a diagram showing a flowchart explaining a process where data transmitted from an external device is transmitted to a data controller according to an embodiment of the present invention;

FIG. 3 is a schematic block diagram explaining a process where data transmitted to the data controller is written in a cache memory according to an embodiment of the present invention;

FIG. 4 is a flowchart explaining a process where data transmitted to the data controller is written in a predetermined position in the cache memory according to an embodiment of the present invention;

FIG. 5 is a schematic block diagram explaining another process where data transmitted to the data controller is written in a cache memory according to an embodiment of the present invention;

FIG. 6 is a diagram showing a flowchart explaining another process where data transmitted to the data controller is written in the cache memory according to an embodiment of the present invention;

FIG. 7 is a schematic block diagram explaining yet another process where data transmitted to the data controller is written in the cache memory according to an embodiment of the present invention;

FIG. 8 is a flowchart explaining yet another process of data transmitted to the data controller being written in the cache memory according to an embodiment of the present invention;

FIG. 9 is a schematic block diagram explaining a process when writing data in duplicate in the cache memory in a conventional storage apparatus; and

FIG. 10 is a flowchart explaining a process when writing data in duplicate in the cache memory in a conventional storage apparatus.

### DESCRIPTION OF THE PREFERRED EMBODIMENTS

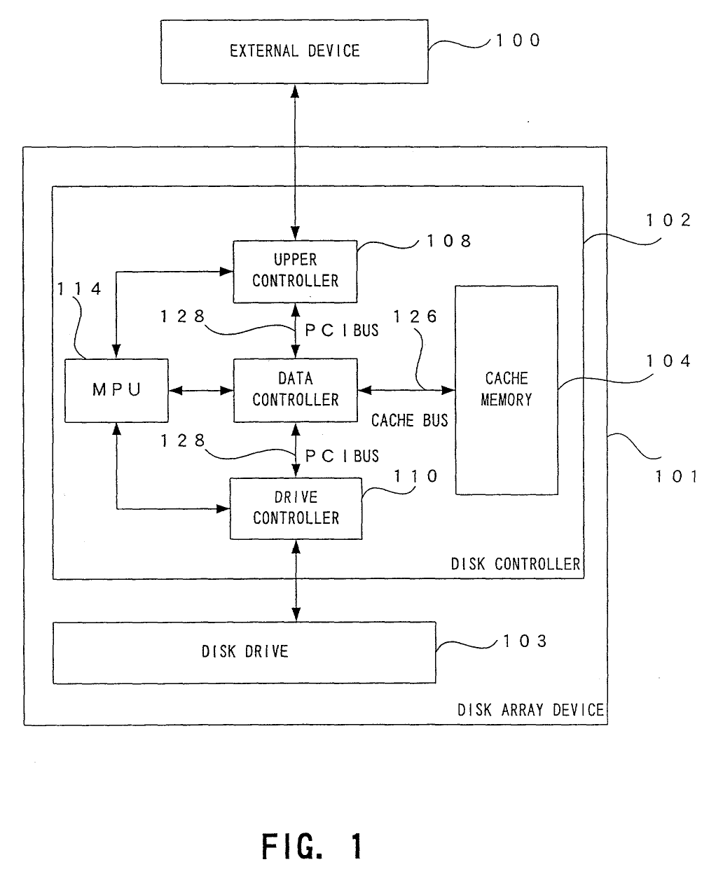

FIG. 1 shows a constitution of a disk array device 101 used in an embodiment of a controlling method according to the present invention. The disk array device 101 is connected to an external device 100 such as a host computer, and comprises a disk controller 102 and a plurality of disk drives 103 controlled by the disk controller 102. Further, the disk controller 102 comprises a microprocessor (MPU) 114, a cache memory 104, a data controller 106 controlling this cache memory 104, a upper controller 108 conducting such as an input/output control of data between the external device 100 and the data controller 106, and a drive controller 110 controlling each disk drive 103. The data controller 106 is connected to the upper controller 108 and the drive controller 110 by such as a PCI bus 128.

Hereinbelow, as an embodiment of the present invention, in the disk array device 101 with the above constitution, a process where data sent from the external device 100 is written to the disk drives 103 is described in detail.

<Embodiment 1>

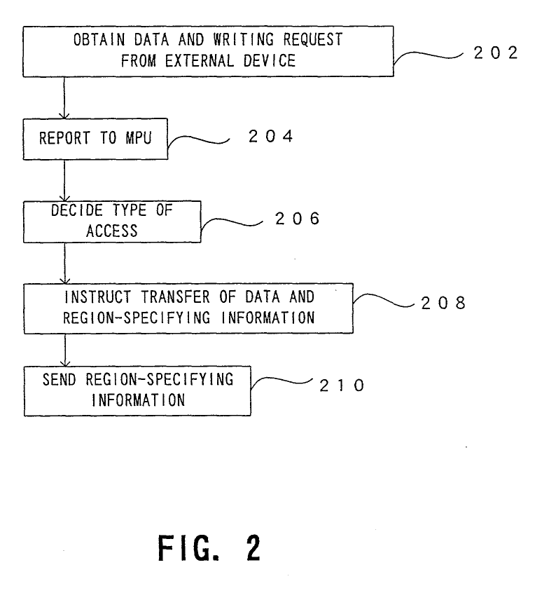

FIG. 2 is a flowchart explaining a process of a disk array device 101 where data sent from an external device 100 to be written in the disk drives is transmitted to a data controller 106. When an upper controller 108 receives, from the external device 100 (S202), data and its writing request, the upper controller 108 interrupts an MPU 114 and sends it a report on the receipt of them (S204). The MPU 114, decodes the signal and determines the type of access (S206), and to the upper controller 108, sends an instruction to transfer the data and a region-specifying information corresponding to the two regions of a cache memory 104 to which the data is written (S208), and sends the region-specifying information (S210).

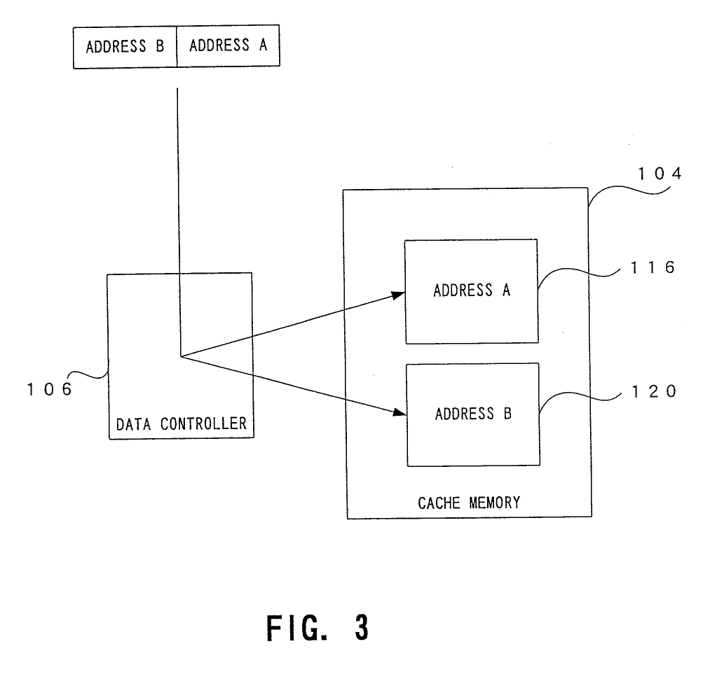

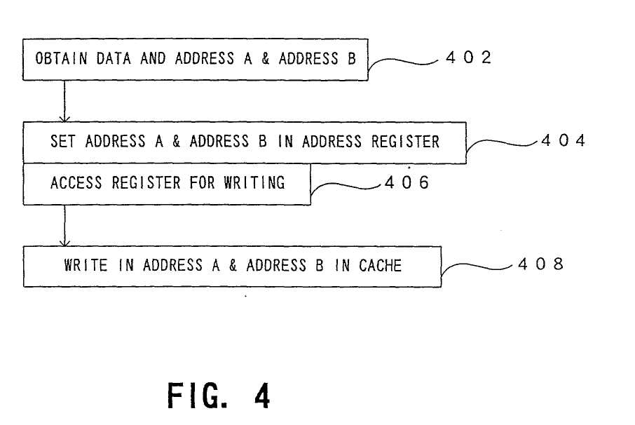

In Embodiment 1, addresses designating the two regions of the cache memory 104 are used as this region-specifying information. FIG. 3 shows its schematic block diagram of a writing process by the data controller 106 in this case, and FIG. 4 shows a flowchart explaining a process in the disk array device 101 where data sent to the data controller 106 is written to a predetermined position in the cache memory 104.

The data controller 106 obtains an address A and an address B, sent from the upper controller 108 by an instruction of the MPU 114 (S402). The data controller 106, sets the address A and the address B sent from the upper controller 108, in an address register (not shown) (S404), accesses a register for writing (not shown) (S406), and writes the data in regions 116, 120 corresponding to the addresses in the cache memory 104 (S408). Then, after the writing ends, the upper controller 108 reports the data transfer completion to the MPU 114, and the data-writing processes to the cache memory 104 are completed.

Thus, data that is written in duplicate in the cache memory 104, after the following procedure, is written to respective corresponding disk drives (storage devices).

Namely, first, the data controller 106, sets the address A and the address B in the address register, and accesses a register for reading (not shown). Next, the data controller 106 reads out data which are written in regions specified by the address A and the address B in the cache memory 104, and transfers the respective data to the drive controller 110. The drive controller 110 receives the data and writes them in the disk drives 103 corresponding to each address. Here management of correspondence of each address and the disk drives 103, is conducted by, for example, a method where a management table is prepared for listing the correspondence to a control memory mounted in the disk controller 102, or where an algorithm is performed which send the correspondence to MPU.

Thus, in the mechanism described above, when data is written in duplicate in the cache memory 104, the data controller 106 writes data simultaneously in the two regions of the cache memory 104. Therefore, the data reading process 118 which becomes necessary in relation to data copying from the address A to the address B is not necessary as conventionally, and the data to be written in the disk drives 103 may be efficiently written in the cache memory 104.

<Embodiment 2>

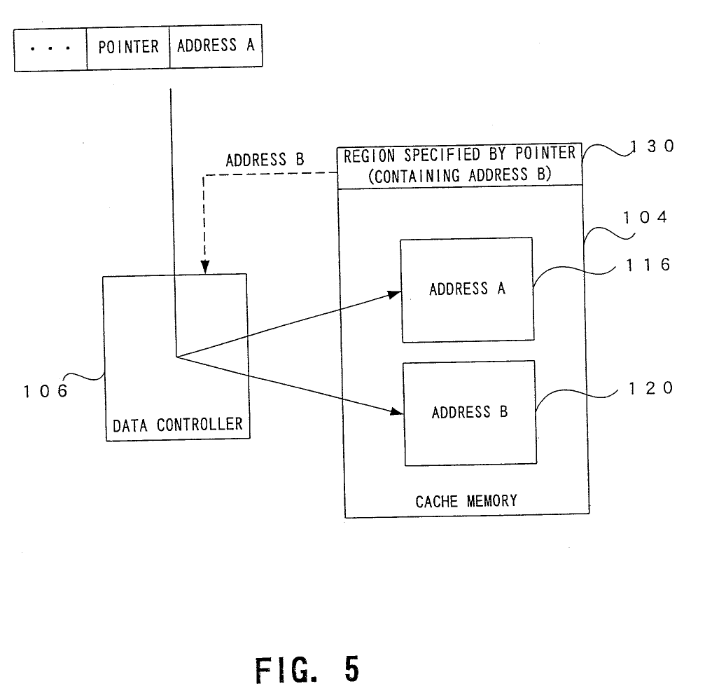

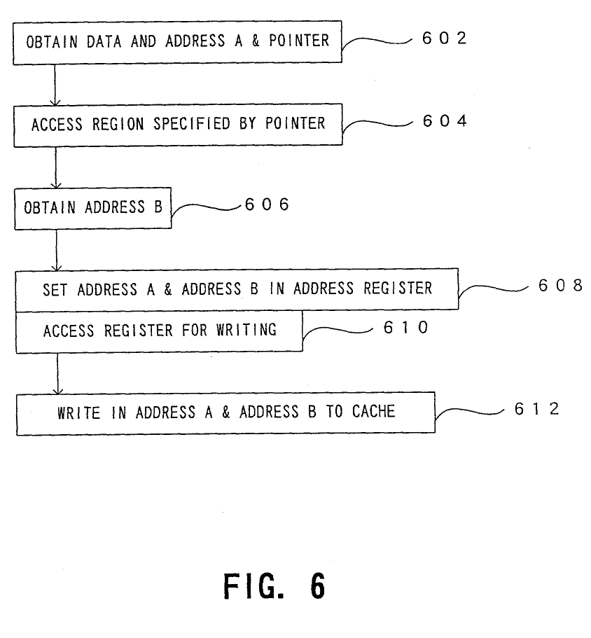

In the embodiment described here, a data controller 106, receives a whole or a part of region-specifying information as a pointer. By reading, for example, an address B stored in a region 130 of a cache memory 104, specified by the pointer, the data controller 106 recognizes a region in the cache memory 104 to which data should be written. Hereinbelow, this mechanism is described referring to a schematic block diagram of FIG. 5, and a flowchart of FIG. 6.

First, the data controller 106 obtains an address A and a pointer from an upper controller 108 (S602). The data controller 106 accesses the specified region 130 of the cache memory 104 (S604) by a pointer value that is sent, and obtains the address B stored in the region 130 (S606). Next, the data controller 106, sets the address A, and the address B obtained by the pointer, to an address register (S608), accesses a register for writing (S610), and writes the data in regions 116, 120 in the cache memory 104 corresponding to the addresses (S612). Then, after the writing ends, the upper controller 108, reports the MPU 114 of the data transfer completion, and the data-writing processes to the cache memory 104 are completed. Note that, since the process where the data in the cache memory 104 is written in the disk drives 103 is the same as that in Embodiment 1, explanation of this process is omitted here.

The explanation described above is a case where only one region-specifying information of the data written in duplicate is specified by the pointer, but another constitution is possible where both information may be specified by two different pointers.

<Embodiment 3>

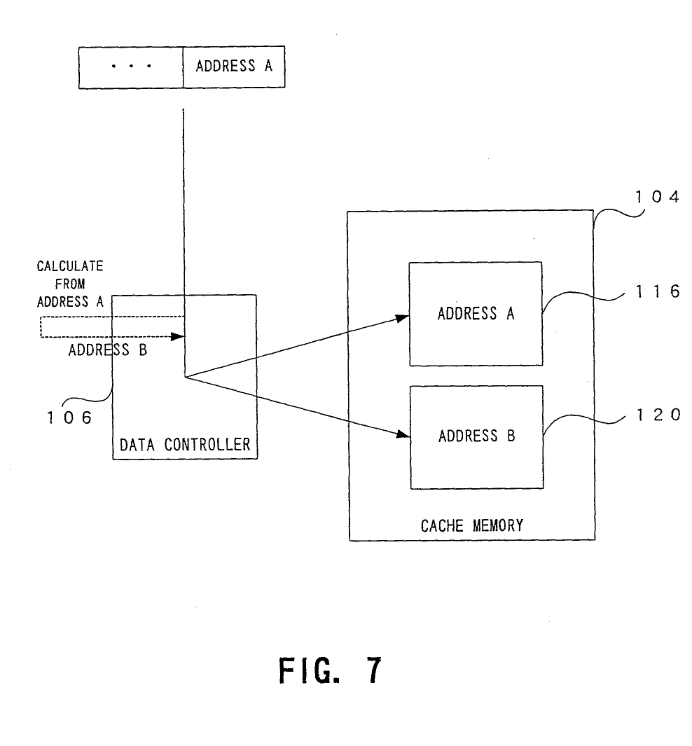

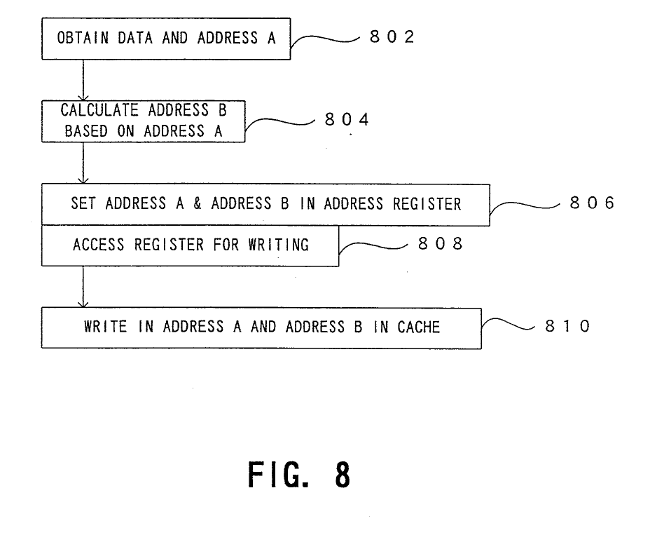

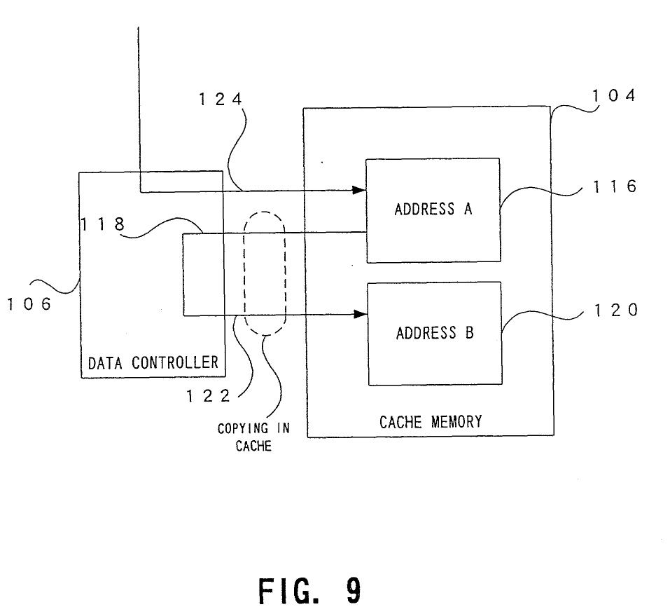

In the following embodiment, a data controller 106 receives, from an external device 100, only one of the addresses of data to be written in cache memory 104 in duplicate as a region-specifying information, and the other address B is determined by applying a predetermined algorithm to the received address. Hereinbelow, this mechanism is described, referring to a schematic block diagram of FIG. 7, and a flowchart of FIG. 8.

First, the data controller 106 obtains an address A that is sent from the upper controller 108 by an instruction from an MPU 114 (S802). Next, the data controller 106, applies the predetermined algorithm to this address A, and determines the other address B (S804).

Here, as a result of the predetermined algorithm, for example, where the address B may be the address A added with a data length of a data to be written, the address B may be a multiple of the address A, or the address B may be the address A added with a predetermined value.

Then, the data controller 106, sets the address A which is sent from the upper controller 108, and the address B which is defined based on the address A in the address register (S806), accesses a register for writing (S808), and writes data in regions 116, 120 corresponding to the address A and the address B in a cache memory 104 (S810). Then, after the writing ends, the upper controller 108 reports the data transfer completion to the MPU 114, and the data-writing processes to the cache memory 104 are completed. Note that, the process when data in the cache memory 104 is written in the disk drives 103 is the same as that in Embodiment 1, thus explanation is omitted here.

In Embodiments 1 to 3 described above, the upper controller 108 is provided inside of the disk controller 102 and, through the upper controller 108, the external device 100 sends data to the data controller 106, but it may be a constitution where the external device 100 directly sends data to the data controller 106. Further, it may be a constitution where the external device 100 determines a data-writing position in the cache memory 104.

Further, the upper controller 108 may specify a region in the cache memory 104 based on the region-specifying information obtained from the external device 100 or the MPU 114, and send the corresponding address to the data controller 106.

Further, although the MPU 114 is described as an independent constituent in the disk controller 102 in the above embodiments, it may have functions of the upper controller 108 and/or the data controller 106.

Thus, the controlling method of the storage apparatus, and the storage apparatus, the disk array device, and the disk controller used in this method of the present invention, when multiplying and managing data, may efficiently conduct the process of writing data in the storage devices.

Although the preferred embodiment of the present invention has been described in detail, it should be understood that various changes, substitutions and alternations can be made therein without departing from spirit and scope of the inventions as defined by the appended claims.

What is claimed is:

1. A controlling method of a storage apparatus, which is connected to an external device and comprises a cache memory, a data controller controlling said cache memory, a plurality of storage devices, and a device controller controlling said storage devices, comprising:
receiving data and a request of writing said data in said storage devices, from said external device into said storage apparatus;
writing said data with said data controller, directly in a plurality of regions in said cache memory; and then
writing said data with said device controller, in said storage devices corresponding to said respective regions in said cache memory.

2. A controlling method of a disk array device, which is connected to an external device and comprises a cache memory, a data controller controlling said cache memory, a plurality of disk drives, and a drive controller controlling said disk drives, comprising:
receiving data and a request of writing said data in said disk drives, from said external device into said disk array device;
writing said data with said data controller, directly in a plurality of regions in said cache memory; and then
writing said data with said drive controller, in said disk drives corresponding to said respective regions in said cache memory.

3. A controlling method of a disk array device according to claim 2, further comprising:
receiving region-specifying information that specifies a region in said cache memory, from said external device into said disc array device, and
writing said data with said data controller, directly in a plurality of regions in said cache memory which are specified based on said region-specifying information.

4. A controlling method of a disk array device, which is connected to an external device and comprises a cache memory, a data controller controlling said cache memory, a upper controller controlling said data controller, a plurality of disk drives, and a drive controller controlling said disk drives, comprising:
receiving data and a request of writing said data in said disk drives, from said external device into said disk array device;
receiving a region-specifying information which specifies a region in said cache memory, from said upper controller into said data controller,
writing said data with said data controller, directly in a plurality of regions in said cache memory which is specified based on said region-specifying information; and then
writing said data with said drive controller, in said disk drives corresponding to said respective regions in said cache memory.

5. A controlling method of a disk array device according to claims 3 or 4, wherein:
said region-specifying information includes at least one address that specifies a region in said cache memory.

6. A controlling method of a disk array device according to claims 3 or 4, wherein:
said region-specifying information includes at least one pointer which specifies a region in said cache memory that stores a second region-specifying information which specifies a region in said cache memory.

7. A controlling method of a disk array device according to claim 6, wherein:
said region-specifying information includes at least one address that specifies a region in said cache memory.

8. A controlling method of a disk array device, which is connected to an external device and comprises a cache memory, a data controller controlling said cache memory, a plurality of disk drives, and a drive controller controlling said disk drives, comprising:
receiving data and a request of writing said data in said disk drives, from said external device into said disk array device;
writing said data with said data controller, directly in a plurality of regions in said cache memory which are specified by an address and another address that is calculated based on the former address; and then
writing said data with said drive controller, in said disk drives corresponding to said respective regions in said cache memory.

9. A controlling method of said disk array device according to claim 8, further comprising:
receiving region-specifying information including at least one address which specifies a region in said cache memory, from said external device into said disc array device; and
writing said data with said data controller, directly in a plurality of regions in said cache memory which are specified by said address and another address that is calculated based on the former address.

10. A controlling method of a disk array device, which is connected to an external device and comprises a cache memory, a data controller controlling said cache memory, a upper controller controlling said data controller, a plurality of disk drives, and a drive controller controlling said disk drives, comprising:
receiving data and a request of writing said data in said disk drives, from said external device into said disk array device;
receiving a region-specifying information including at least one address that specifies a region in said cache memory, from said upper controller into said data controller;
calculating another address based on said address with said data controller;
writing said data with said data controller, directly in a plurality of regions in said cache memory specified by said addresses; and then
writing said data with drive controller, in said disk drives corresponding to said respective regions in said cache memory.

11. A storage apparatus connected to an external device, comprising:
a cache memory, a data controller comprising means to write data, directly in a plurality of regions in said cache memory, and a plurality of storage devices;
means to receive, from said external device, data and a request of writing said data in said storage devices; and
means to write said data in said storage devices.

12. A disk array device connected to an external device, comprising:
a cache memory, a data controller comprising means to write data, directly in a plurality of regions in said cache memory, and a plurality of disk drives;
means to receive, from said external device, data and a request of writing said data in said disk drives; and
means to write said data in said disk drives.

13. A disk controller, connected to an external device and a plurality of disk drives, comprising:
a cache memory, and a data controller comprising said means to write data, directly in a plurality of regions in said cache memory;
means to receive, from said external device, data and a request of writing said data in said disk drives; and means to write said data in said disk drives.
